(19) United States
(12) Patent Application Publication
(10) Pub. No.: US 2018/0197182 A1
(43) Pub. Date: Jul. 12, 2018

(54) Systems and Methods for Implementing Fraud Prevention Rules at Proximate Merchants

(71) Applicant: MASTERCARD INTERNATIONAL INCORPORATED, Purchase, NY (US)

(72) Inventors: Srinivasarao Nidamanuri, Chesterfield, MO (US); Vincent Alain Haulotte, Manchester, MO (US); Gregory Goodman, Villa Ridge, MO (US)

(21) Appl. No.: 15/403,525

(22) Filed: Jan. 11, 2017

(51) Int. Cl. G06Q 20/40; G01C 21/34

(52) U.S. Cl. CPC G06Q 20/4016; G01C 21/3407

(57) ABSTRACT

Systems and methods are provided for implementing at least one fraud prevention rule associated with a detected fraud condition. An example method includes detecting a fraud condition associated with a source merchant, where the fraud condition includes multiple suspect transactions and where each one of suspect transactions has a parameter that is substantially consistent with the other ones of the suspect transactions. The method also includes identifying a like merchant based on a proximity of the like merchant to the source merchant, and determining a travel time between the source merchant and the like merchant. The method further includes deploying at least one fraud prevention rule at the like merchant during a fraud risk interval, where the at least one fraud prevention rule is based on the parameter of at least one of the suspect transactions and where the fraud risk interval is based on the determined travel time.

### FIELD

The present disclosure generally relates to systems and methods for use in implementing fraud prevention rules at proximate merchants, and in particular, to implementing fraud prevention rules, based on detected fraud conditions at source merchants, at merchants proximate to the source merchants.

### BACKGROUND

This section provides background information related to the present disclosure which is not necessarily prior art.

Payment accounts are used by consumers to perform numerous different transactions including, for example, purchasing products (e.g., goods and/or services) from merchants, etc. In connection with the transactions, the consumers often provide payment credentials associated with the payment accounts to the merchants, often via payment devices such as, for example, payment cards or payment applications. In turn, the merchants verify, through one or more payment networks, that the payment accounts are usable to fund the transactions. Sometimes, payment devices and/or payment credentials associated with the payment accounts are obtained by individuals not authorized to the use the payment accounts. These individuals then employ the payment accounts in fraudulent transactions. In connection therewith, the payment networks, as well as issuers of the payment accounts, often apply different rules to attempt to detect and inhibit such fraudulent transactions.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in implementing fraud prevention rules, based on detected fraud conditions at source merchants, at merchants proximate to the source merchants;

FIG. 2 is a block diagram of an exemplary computing device that may be used in the system of FIG. 1; and

FIG. 3 is an exemplary method, which may be implemented via the system of FIG. 1, for implementing one or more fraud prevention rules, based on a detected fraud condition at a source merchant, at one or more merchants proximate to the source merchant.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Payment accounts are often used to fund transactions at merchants for the purchase of products. Typically, in using the payment accounts, consumers are authenticated as a mechanism to help inhibit unauthorized transactions. In addition, issuers of the payment accounts and/or payment networks associated with processing the transactions may implement fraud prevention rules to further help inhibit occurrences of unauthorized transactions. Uniquely, the systems and methods herein impose fraud prevention rules for use in detecting and/or preventing unauthorized transactions at one or more merchants, based on occurrences of fraudulent transactions at related source merchants. In particular, when a fraud condition is detected at a source merchant (which is caused by an unauthorized user (or multiple unauthorized users) of a payment account, i.e., a fraudster (or fraudsters)), a fraud engine identifies one or more like merchants (or similar or related merchants), for example, that are proximate to the source merchant, and then determines a travel time from the source merchant to each of the one or more like merchants. Based on the travel time, the fraud engine determines an interval during which the unauthorized user would be able to arrive at the like merchants and attempt one or more similar fraudulent transactions (i.e., a fraud risk interval). The fraud engine then compiles one or more fraud prevention rules associated with the detected fraud condition and imposes the rules at the like merchants based on the fraud risk interval. In this manner, the fraud engine is able to protect the like merchants (that are proximate the source merchant) from fraudulent transactions having the same or similar characteristics to the fraudulent transactions at the source merchant. When the fraud risk interval expires, the fraud engine withdraws the fraud prevention rules, thereby limiting potential impact of the rules on non-fraudulent transactions.

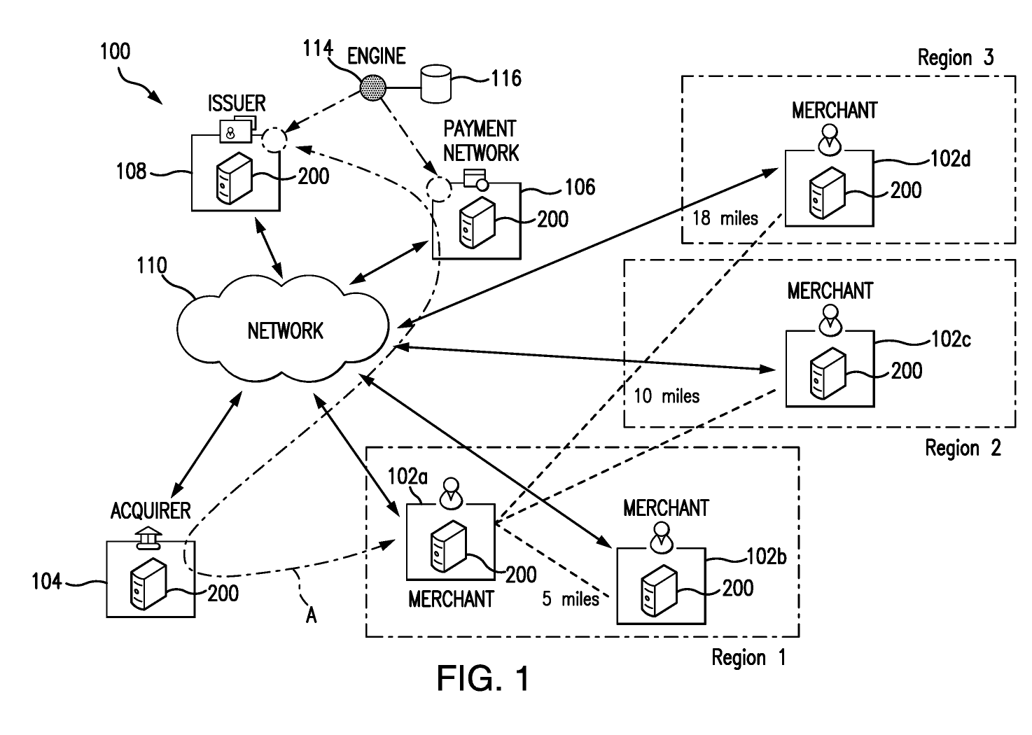

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise, depending on, for example, implementation of fraud detection and/or prevention rules, etc.

As shown in FIG. 1, the illustrated system 100 generally includes multiple merchants 102a-d, an acquirer 104, a payment network 106, and an issuer 108 configured to issue payment accounts to consumers, each coupled to (and in communication with) a network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 110 includes multiple networks, where different ones of the multiple networks are accessible to different ones of the illustrated parts in FIG. 1. In particular in this example, the acquirer 104, the payment network 106, and the issuer 108 may be connected via a private payment transaction network that is part of network 110 for processing payment account transactions, and the merchants 102a-d may be connected with consumers for effecting payment account transactions, for example, through a public network, such as the Internet, that is also part of network 110.

In this exemplary embodiment, the system 100 includes four different merchants 102a-d configured to offer products (e.g., goods, services, etc.) for sale to consumers. However, it should be appreciated that the system 100 may include any number of merchants within the scope of the present disclosure. As shown, each of the merchants 102a-d includes a physical location (e.g., a brick-and-mortar location, etc.) within one of region 1, region 2, and region 3, at which such products are offered for sale. In particular, the merchants 102a-b are in region 1, while the merchant 102c and the merchant 102d are in region 2 and region 3, respectively. In addition, the regions 1-3 may be adjacent, or not, and may be defined as territories, states, cities, counties, countries, postal codes, etc. In one example, each of the regions 1-3 is defined by a different postal code. Further, in the illustrated system 100, the merchants 102b-d are spaced apart from the merchant 102a by the various exemplary distances listed in FIG. 1 (as indicated by the dotted lines). Specifically, for example, the merchant 102b is five miles from the merchant 102a; the merchant 102c is ten miles from the merchant 102a; and the merchant 102d is eighteen miles from the merchant 102a.

Also in this exemplary embodiment, each of the merchants 102a-d is assigned the same merchant category code (MCC). As such, each of the merchants 102a-d includes common products offered for sale to the consumers (e.g., each may offer a Brand X, Y-inch television; etc.), or common classes, categories and/or types of products (e.g., appliances, electronic devices, televisions, tablets, computers, etc.). However, it should be appreciated that, in other embodiments, one or more of the merchants 102a-d may have different MCCs, or multiple MCCs without none, one or more in common. In addition, it should be appreciated that the merchants 102a-d may further be associated with one another based on data other than MCCs. For example, the merchants 102a-d may share a common name, a type of point-of-sale (POS) terminal, a location, a postal code, a product offering, a category other than MCC, etc.

In the system 100, consumers are associated with payment accounts, through which the consumers fund transactions with the merchants 102a-d for the purchase of products. In particular in the system 100, a payment account is provided (or issued) to a consumer by the issuer 108. The payment account, then, is generally represented by one or more payment devices (e.g., payment cards, fobs, virtual payment devices contained in an electronic wallet, etc.) that may be used by the consumer at the merchants 102a-d for the purchase of the products.

In an exemplary payment account transaction, the consumer may seek to purchase food from the merchant 102a, using the payment account to fund the purchase. As such, the consumer presents a payment device to the merchant 102a. In connection therewith, the merchant 102a receives and/or retrieves credentials for the consumer's payment account from the payment device, for example, via a POS terminal, and communicates an authorization request through the network 110 (along path A in FIG. 1) to the acquirer 104 (associated with processing transactions at the merchant 102a). In turn, the acquirer 104 communicates with the issuer 108 (associated with the consumer's payment account), through the payment network 106 (again via the network 110), for authorization of the transaction (e.g., to determine if the consumer's payment account is in good standing and if there is/are sufficient credit/funds to complete the transaction, etc.). If the issuer 108 accepts the transaction, an authorization reply is provided back to the merchant 102a (again, generally along path A) approving the transaction, and the merchant 102a is then able to proceed in the transaction. The transaction is later cleared and settled by and between the merchant 102a and the acquirer 104 and by and between the acquirer 104, the payment network 106, and the issuer 108 (in accordance with settlement arrangements, etc.). Conversely, if the issuer 108 declines the transaction, an authorization reply is provided back to the merchant 102a declining the transaction, and the merchant 102a is able to terminate the transaction with the consumer, or request an alternate form of funding.

While described with reference to the merchant 102a, it should be appreciated that transactions between consumers and merchants 102b-d, and funded by payment accounts associated with the consumers, will be substantially consistent with the example transaction described above (but may include the same or different acquirers, payment networks, and/or issuers, etc.), depending on the payment accounts, the consumers, and/or the particular ones of the merchants 102b-d involved, for example.

Transaction data is generated, collected, and stored as part of the above interactions among the merchant 102a (as well as for transactions involving the other merchants 102b-d), the acquirer 104, the payment network 106, the issuer 108, and the consumer. The transaction data represents at least a plurality of transactions, for example, completed transactions, attempted transactions, etc. The transaction data, in this exemplary embodiment, is stored at least by the payment network 106 (e.g., in a data structure associated with the payment network 106, etc.). Additionally, or alternatively, the acquirer 104 and/or the issuer 108 may store the transaction data, or part thereof, in a data structure. The transaction data may be stored in any desired manner in the system 100. With that said, transaction data may include, for example, payment account numbers, amounts of transactions, merchant IDs, MCCs, region codes for the merchants 102a-d (or other merchants) involved in transactions and/or POS terminals associated with the merchants (or other merchant location identifiers and/or transaction location identifiers), merchant DBA names, dates/times of transactions, products purchased and related descriptions or identifiers, etc. It should be appreciated that more or less information related to transactions, as part of either authentication of consumers, authorization and/or clearing and/or settling, may be included in transaction data and stored within the system 100, at the merchants 102a-d, the acquirer 104, the payment network 106, and/or the issuer 108. Further, data unrelated to particular payment accounts may be collected by a variety of techniques, and similarly stored within the system 100.

In various exemplary embodiments, consumers involved in the different transactions herein are prompted to agree to legal terms associated with their payment accounts, for example, during enrollment in their accounts, etc. In so doing, the consumers and merchants may voluntarily agree, for example, to allow issuers of the payment accounts, payment networks, etc., to use data collected during enrollment and/or collected in connection with processing the transactions, subsequently for one or more of the different purposes described herein.

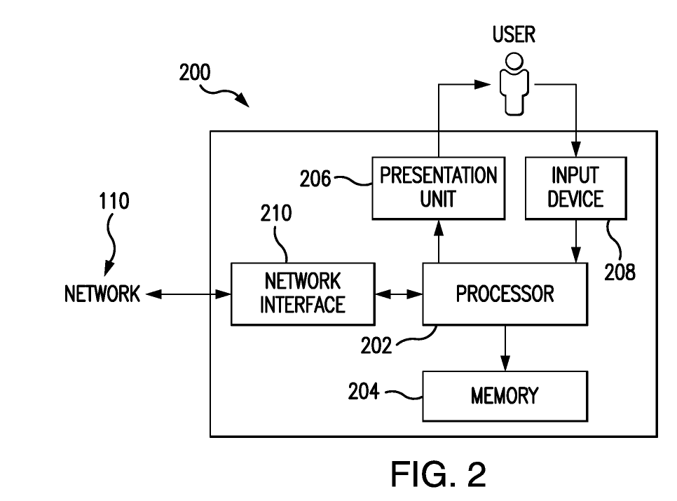

FIG. 2 illustrates an exemplary computing device 200 that can be used in the system 100. The computing device 200 may include, for example, one or more servers, workstations, personal computers, laptops, tablets, smartphones, POS terminals, other suitable computing devices, etc. In addition, the computing device 200 may include a single computing device, or it may include multiple computing devices located in close proximity, or multiple computing devices distributed over a geographic region, so long as the computing devices are specifically configured to function as described herein. In the system 100, each of the merchants 102a-d, the acquirer 104, the payment network 106, and the issuer 108 are illustrated as including, or being implemented in, computing device 200, coupled to (and in communication with) the network 110. However, the system 100 should not be considered to be limited to the computing device 200, as described below, as different computing devices and/or arrangements of computing devices may be used.

Referring to FIG. 2, the exemplary computing device 200 generally includes a processor 202 and a memory 204 coupled to (and in communication with) the processor 202. The processor 202 may include one or more processing units (e.g., in a multi-core configuration, etc.) including, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein. The above examples are exemplary only, and are not intended to limit in any way the definition and/or meaning of processor.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204, and/or data structures included therein, may be configured to store, without limitation, transaction data, other data relating to the merchants 102a-d (e.g., including relational geographic data between the merchants 102a-d, etc.), and/or other types of data and/or information suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. It should be appreciated that the memory 204 may include a variety of different memories, each implemented in one or more of the functions or processes described herein.

The computing device 200 also includes a presentation unit 206 (or output device or display device) that is coupled to (and is in communication with) the processor 202 (however, it should be appreciated that the computing device 200 could include output devices other than the presentation unit 206, etc.). The presentation unit 206 outputs information, either visually or audibly to a user of the computing device 200, for example, a consumer, a user associated with either the payment network 106 or the issuer 108 in the system 100, individuals associated with other parts of the system 100, etc. It should be further appreciated that various interfaces may be displayed at computing device 200, and in particular at presentation unit 206, to display information, such as, for example, transaction data, etc. The presentation unit 206 may include, without limitation, a liquid crystal display (LCD), a light-emitting diode (LED) display, an organic LED (OLED) display, an “electronic ink” display, etc. In some embodiments, presentation unit 206 includes multiple devices.

The computing device 200 further includes an input device 208 that receives inputs from the user of the computing device 200 (i.e., user inputs) such as, for example, selection of certain MCCs, selection of particular ones of the merchants 102a-d, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. In various exemplary embodiments, a touch screen, such as that included in a tablet, a smartphone, or similar device, behaves as both a presentation unit 206 and an input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces incorporated into or with the processor 202.

Referring again to FIG. 1, the system 100 includes a fraud engine 114 configured, by computer executable instructions, for example, to perform one or more of the operations herein. As indicated by the dotted lines, the fraud engine 114 may be incorporated into the payment network 106 and/or the issuer 108 (e.g., as part of the corresponding computing device 200, etc.). Alternatively, the fraud engine 114 may be incorporated into other entities in the system 100 or even other entities not in the system 100 (e.g., a service provider, etc.), depending on, for example, a manner in which fraud detection and/or prevention is employed. Further, in various embodiments, the fraud engine 114 may be a standalone device (and, for example, may be consistent with computing device 200, etc.), potentially in communication with one or more of the payment network 106 and the issuer 108 to facilitate operation as described herein.

In general, the fraud engine 114 is configured to detect a fraud condition at one of the merchants 102a-d (as a source merchant), and to then automatically implement at least one fraud prevention rule at one or more of the other merchants 102a-d (as like merchants that are proximate to the source merchant). In so doing, the fraud engine 114 permits the detected fraud condition to generally automatically alter fraud prevention rules associated with at least one of the merchants 102a-d (as like merchants) to target fraud at the merchants 102a-d consistent with the detected fraud condition.

As an example, the fraud engine 114 is configured to monitor for fraud conditions at the merchants 102a-d (e.g., based on transaction data available to the fraud engine 114 in the system along path A in FIG. 1, at the payment network 106, at the issuer 108, etc.). Then, upon detection of a fraud condition at the merchant 102a (broadly, a source merchant), for example, the fraud engine 114 is configured to identify one or more like merchants to merchant 102a. For example, the engine 114 may be configured to identify the like merchants (e.g., one or more of merchants 102b-d (or other merchants), etc.) based on their location or proximity relative to the merchant 102a (e.g., based on their region being the same as the region of the source merchant 102a (e.g., within the same zip code, the same city, the same county, some other region-based grouping, etc.), based on one or more distance thresholds relative to the source merchant 102a (e.g., a five mile radius, a ten mile radius, a twenty mile radius, a fifty mile radius, some other radius that provides the fraud engine 114, the payment network 106, the issuer 108, etc. time to ultimately address the identified fraud condition and alert merchants, etc.); other distance measures (other than radius); etc.), and further based on their MCC(s) (or other category such as product category, etc.) relative to the merchant 102a.

Next, for each of the identified like merchants, the fraud engine 114 is configured to determine a distance between the source merchant 102a and the like merchant and to estimate and/or determine a travel time from the merchant 102a to the like merchant. Also for each of the identified like merchants, the fraud engine 114 is configured to compile rules associated with the detected fraud condition (as detected at the merchant 102a) and store the rules in data structure 116. And, the fraud engine 114 is configured to implement the rules at the like merchant upon detection of the fraud condition, during a time interval based on the determined travel time to the particular identified like merchant (e.g., a fraud risk interval comprising the determined travel time plus/minus a time factor (e.g., one minute, five minutes, six minutes, ten minutes, etc.) to account for purchase time by the user, etc.). In connection therewith, the fraud engine 114 is configured to automatically impose the rules (and/or different rules) at the like merchant (e.g., at a location along path A in FIG. 1 upon receiving an authorization request for a transaction from the like merchant, etc.), for the appropriate time interval, and then retract/withdraw the rules after the particular time interval is expired (e.g., if no fraud condition is detected at the like merchant, etc.). As can be appreciated, the automatically imposed rules may provide initial protection to the like merchants against the detected fraud condition, potentially at a time prior to manual identification of the fraud condition (e.g., providing stop gap protection for the merchants prior to the fraud condition being ultimately addressed, etc.).

With that said, as can be appreciated, the operations described above can subsequently be applied to one of the identified like merchants as well, for example, when the fraud condition is also detected at the identified like merchant (such that the like merchant essentially becomes a source merchant). As such, the fraud engine 114 may be configured to also continually monitor/track the given fraud condition at the subsequent like merchants, as appropriate, for example, until the given fraud condition is no longer present or no longer a concern.

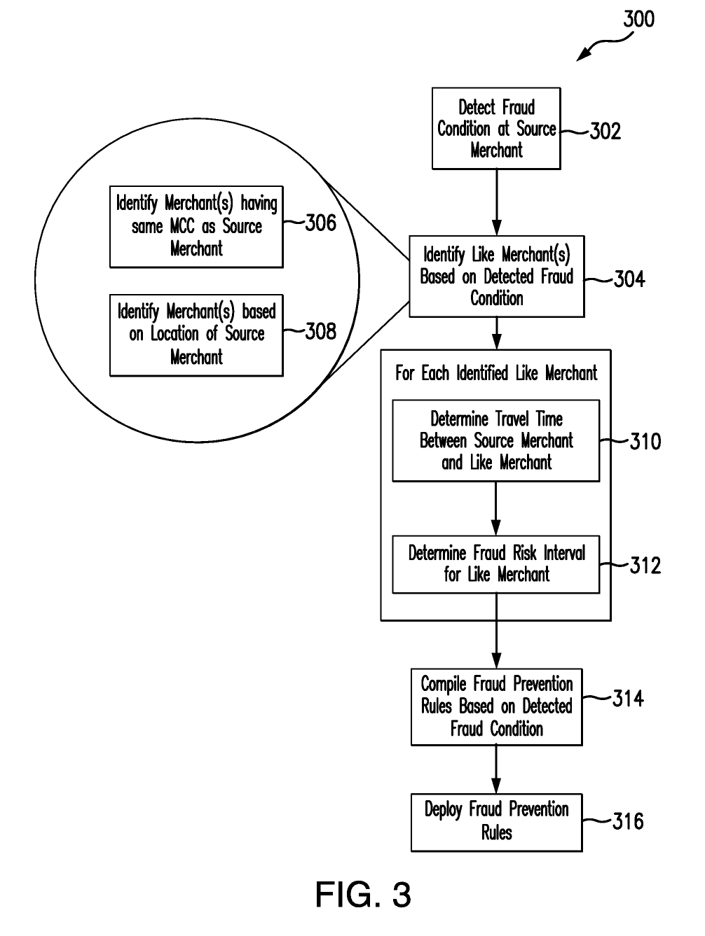

Additional detail regarding the operation of the fraud engine 114 is provided below with reference to method 300. As such, it should be appreciated that the fraud engine 114 is further configured to perform the operations of the method 300 described below and with reference to FIG. 3.

FIG. 3 illustrates exemplary method 300 for use in detecting a fraud condition at a source merchant and then implementing fraud prevention rules at one or more merchants proximate to the source merchant, based on the detected fraud condition. The exemplary method 300 is described with reference to the system 100 (e.g., as implemented in the fraud engine 114, etc.) and the computing device 200. Nonetheless, it should be appreciated that the methods herein are not limited to the exemplary system 100 or the exemplary computing device 200 and, similarly, that the systems and computing devices herein are not limited to the exemplary method 300.

As shown in FIG. 3, the fraud engine 114 initially detects a fraud condition at the merchant 102a (broadly, a source merchant), at 302. In the illustrated method 300, such detection is via the payment network 106 and/or the issuer 108 (with the fraud engine 114 implemented at least partly in the payment network 106 and/or the issuer 108). However, in other embodiments, detection of the fraud condition may be performed directly by the fraud engine 114 (based on rules, models, etc. as described herein).

In the method 300, the fraud condition relates to a flash fraud event, in which one or more unauthorized individuals attempt multiple transactions at merchant 102a for about the same general amount and using payment devices associated with multiple different payment accounts. In general, a flash fraud event includes a large amount of fraud in a very short period of time, with the fraud pattern being very similar because the unauthorized individuals taking part in the flash fraud event are following a known or common modus operandi. As such, the individuals perform multiple transactions around the same amount at similar merchants for similar products (i.e., perform transactions having similar parameters). As described above, a variety of different fraud rules and/or models may be implemented (e.g., by the payment network 106 and/or the issuer 108 via the fraud engine 114, etc.) to initially detect the flash fraud event, and then to detect subsequent activities relating to the flash fraud event. Such rules and/or models may take into account similarities in amounts of the multiple transactions (taking into account potential price ranges of the products being purchased and tax differences, etc.), frequencies of the transactions, involved merchants, whether the same or different payment accounts are involved, etc.

As an example, the flash fraud event may include multiple suspect transactions repeatedly initiated at the merchant 102a (broadly, a parameter) for the same computer (broadly, a parameter), priced at $450 (broadly, a parameter), using multiple different payment devices (associated with multiple different payment accounts), or even using the same payment device (or copies thereof) associated with a single payment account. In connection therewith, the merchant 102a may seek authorization for each of the transactions for about $450 plus tax (e.g., for $450 plus 2-7% for tax, etc.). Initial detection of the flash fraud event (at 302) may be based on a variety of different fraud rules and/or models implemented by the payment network 106 and/or the issuer 108. For example, the fraud rules and/or models may detect multiple, repeated transactions for matching or very similar amounts as a flash fraud event after a predefined number of the transactions are initiated at the merchant 102a within a predefined time period (or trigger interval) (e.g., five or six repeated transactions within two, three or four minutes; etc.). Once detected, further transactions involving the payment accounts may be declined at the merchant 102a.

Then, once the fraud condition is detected in the method 300, the fraud engine 114 identifies, at 304, additional, like merchants at which the unauthorized individuals performing the fraudulent transactions might migrate to perform similar transactions, upon decline of the transactions at merchant 102a. In so doing, in this example, the fraud engine 114 takes into account MCC of the merchant 102a and location of the merchant 102a. Specifically in this example, the fraud engine 114 identifies, at 306, merchants having the same MCC as the merchant 102a and identifies, at 308, merchants having a similar location to the merchant 102a (e.g., merchants located in the same region as merchant 102a, within a predefined radius of the merchant 102a, etc.). As described above, the similar location may include a similar location parameter that allows (or provides sufficient time for) the fraud engine 114, the payment network 106, the issuer 108, etc. to ultimately address the identified fraud condition and otherwise alert merchants in general of the potential fraud. However, in other embodiments, other features (other than MCC and/or location) may be used to identify like merchants such as, for example, merchant industry (e.g., grocery store, pharmacy, etc.), products sold, etc. Further, in still other embodiments, the fraud engine 114 may use predefined lists of like merchants to thereby identify like merchants to merchant 102a.

As described above for the system 100, in this example each of the merchants 102b-d have the same MCC as the merchant 102a. Of these, merchant 102b is in the same region (region 1) as the merchant 102a. As such, in this example, the fraud engine 114 identifies the merchant 102b as a like merchant to merchant 102a. In addition, in some implementations of the method 300, the fraud engine 114 may additionally identify merchants in adjacent regions to the merchant 102a as like merchants, for example, merchant 102c (in region 2). Further still, in some implementations, the fraud engine 114 may additionally (or alternatively) identify merchants within twenty miles (or other measure) of the merchant 102a (i.e., within a predefined distance threshold of the merchant 102a) as like merchants, for example, each of merchants 102b-d (based on the exemplary distances illustrated in FIG. 1).

When the like merchants are identified (at 304), the fraud engine 114 next determines, at 310, a travel time (e.g., a drive time, etc.) from the source merchant 102a to each of the identified like merchants. Specifically, for example, the fraud engine 114 may retrieve the travel time to each of the identified merchants from a third-party provider (e.g., Google Maps, etc.) via an application programming interface (API). In some embodiments, the fraud engine 114 may instead specify to the third-party provider criteria relating to a predetermined distance/location in which to locate potential like merchants and criteria associated with the potential like merchants, via the API, whereby the third-party provider then transmits an indication of merchants to the fraud engine 114 that satisfy the criteria (e.g., the third-party provider may be used in conjunction with the fraud engine 114 to determine the like merchants, etc.). Regardless, in various embodiments, the results may then be limited/filtered, for example, to the closest three to five like merchants, etc.

Next, at 312, the fraud engine 114 determines a fraud risk interval associated with the detected fraud condition, for each of the identified like merchants. The fraud risk interval takes into account, for example, a drive time from the source merchant 102a to each of the identified like merchants (broadly, the location of the like merchants), as well as a cushion relating to parking, waiting in line to make a purchase, etc. (broadly, a deployment interval at the like merchants).

For example, as described above, if the flash fraud event in the method 300 (broadly, the fraud condition) includes the repeated purchases of a computer for $450 plus tax (at source merchant 102a), the fraud engine 114 may determine that a travel time for an unauthorized user from the source merchant 102a to an identified like merchant is seven minutes (e.g., a drive time to the closest like merchant; a drive time to the farthest like merchant within the given region, radius, etc.; an average drive time based on each of the like merchants within the given region, radius, etc.; etc.). The fraud engine 114 may also determine that, upon arrival at the identified like merchant, it would take the unauthorized user about three minutes to exit his/her vehicle, and it would further take the unauthorized user about five minutes to enter the merchant, retrieve the computer for purchase, and travel to a POS terminal to make the purchase (e.g., including standing in line at the POS terminal, etc.) (as a deployment time/interval). Based thereon, the fraud engine 114 may determine a fraud risk interval, for the identified like merchant, to begin at 15 minutes (e.g., the seven minute travel time plus the eight minute deployment interval or period once at the merchant, etc.) beyond the last attempted transaction at the source merchant 102a. Then, the fraud engine 114 assigns a particular fraud risk interval to the identified like merchant based on the determined travel time. In particular, the fraud engine 114 may assign a first fraud risk interval (e.g., 20 minutes, etc.) for each identified like merchant having a determined travel time at or under a desired threshold (e.g., 15 minutes, etc.), and a second fraud risk interval (e.g., 30 minutes, etc.) for each identified like merchant having a determined travel time over the desired threshold. Here, the two fraud risk intervals may account for differences and/or variations in the travel times to the different like merchants and/or a time for the fraud engine 114, the payment network 106, the issuer 108, etc. to ultimately address the identified fraud condition and otherwise alert merchants in general of the potential fraud; in other embodiments, more than two different fraud risk intervals may be used (based on different travel time thresholds, based on effectiveness of other fraud models in place, etc.). It should be appreciated that the fraud risk interval may run for a period of minutes, hours, or longer depending on the particular implementation of the fraud engine 114.

Table 1 illustrates various relative data between merchant 102a (as the source merchant) and merchants 102b-d, when identified as like merchants to the merchant 102a. In particular, Table 1 illustrates the distance (in miles) between the merchant 102a and each of the like merchants 102b-d, and a determined travel time between the merchant 102a and each of the merchants 102b-d (as determined by the fraud engine 114, for example, at 310 in the method 300). Table 1 also includes a fraud risk interval for each of the merchants 102b-d (as determined by the fraud engine 114, for example, at 312 in the method 300). In particular in the example shown in Table 1, the fraud engine 114 assigns a fraud risk interval of 20 minutes to the like merchants having travel times at or under 15 minutes, and 30 minutes to the like merchants having travel times over 15 minutes. In connection therewith, for merchant 102b, which has a travel time and deployment interval of 15 minutes, the fraud risk interval extends from 1:37 pm to 1:57 pm (based on a last fraud attempt at the source merchant 102a, at 1:22 pm). The fraud risk intervals for merchants 102c-d are similarly calculated by the fraud engine 114 (with merchant 102c having a travel time and deployment interval of 22 minutes (i.e., 14 minutes of travel time plus 8 minutes of shopping time at the merchant 102c), and merchant 102d having a travel time and deployment interval of 36 minutes (i.e., 28 minutes of travel time plus 8 minutes of shopping time at the merchant 102d).

TABLE 1

| Merchant | Distance | Travel Time | Fraud Risk Interval |
|---|---|---|---|
| Merchant 102b | 5 miles | 7 minutes | 1:37-1:57pm (20 minutes) |
| Merchant 102c | 10 miles | 14 minutes | 1:44-2:04pm (20 minutes) |
| Merchant 102d | 18 miles | 28 minutes | 1:58-2:28pm (30 minutes) |

With continued reference to FIG. 3, the fraud engine 114 compiles various fraud prevention rules, at 314, based on the detected fraud condition at the source merchant 102a (e.g., based on a parameter of a transaction at the merchant 102a associated with the fraud condition, etc.), and automatically deploys the rules to the identified like merchants, at 316, for their particular fraud risk intervals. As an example, the fraud prevention rules may relate to a transaction amount at the identified like merchants, which is within a threshold of an amount of at least one of the suspect transactions at the source merchant 102a. For example, regarding the repeated purchase of the computer for $450 plus tax at source merchant 102a (as the fraud event), the fraud engine 114 may compile a further fraud prevention rule directing the like merchants to decline transactions having the following parameters: transaction amount between $450+/−10%, POS entry mode is card present and magstripe, and transaction date/time is within fraud risk interval. Then, when the fraud risk intervals expire for the given like merchants, the fraud engine 114 withdraws the various fraud prevention rules (that were implemented based on the detected fraud condition at the source merchant 102a).

In view of the above, the systems and methods herein generate fraud prevention rules for use in detecting and/or preventing unauthorized transactions at one or more merchants, and automatically deploy such rules, based on occurrences of fraudulent transactions at related source merchants involving flash fraud events. Uniquely, when such fraudulent transactions are initially detected at the source merchants, the newly developed fraud prevention rules (specifically directed to the recently detected flash fraud events) are generally deployed automatically by the fraud engine, for example, thereby putting various safeguards in place to stop the fraudulent actions from further occurring at other merchants (and, for example, potentially providing authorities time to investigate the initial occurrences associated with the flash fraud events). In addition, as the newly developed fraud prevention rules are based on both transaction details and location associated with the flash fraud events, they can be effective in inhibiting further fraud loss, by instantly declining subsequent transactions within the target location, while minimally impacting other potentially valid transactions.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of: (a) detecting a fraud condition associated with a source merchant, the fraud condition including multiple suspect transactions, each suspect transaction having a parameter, the parameter of each transaction being substantially consistent; (b) identifying at least one like merchant based on a proximity of the at least one like merchant to the source merchant; (c) determining a travel time between the source merchant and the at least one like merchant; (d) deploying at least one fraud prevention rule at the at least one like merchant during a fraud risk interval, the at least one fraud prevention rule based on the parameter of at least one of the multiple suspect transactions, and the fraud risk interval based on the determined travel time, thereby permitting the detected fraud condition to alter one or more other fraud prevention rules associated with the at least one like merchant, based on the deployed at least one fraud prevention rule, to target fraud at the at least one like merchant consistent with the detected fraud event; and (e) withdrawing the at least one fraud prevention rule after the fraud risk interval.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “connected to,” “coupled to,” or “in communication with” another feature, it may be directly on, connected or coupled to, or in communication with the other feature, or intervening features may be present. In contrast, when a feature is referred to as being “directly on,” “directly connected to,” “directly coupled to,” or “directly in communication with” another feature, there may be no intervening features present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature could be termed a second feature without departing from the teachings of the example embodiments.

None of the elements/features recited in the claims are intended to be a means-plus-function element within the meaning of 35 U.S.C. § 112(f) unless an element is expressly recited using the phrase “means for,” or in the case of a method claim using the phrases “operation for” or “step for.”

Further, the disclosure herein of particular values is not exclusive of other values that may be useful in one or more of the examples disclosed herein.

And again, the foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in providing at least one fraud prevention rule associated with a detected fraud condition, the method comprising:
detecting, by a computing device, a fraud condition associated with a source merchant, the fraud condition including multiple suspect transactions, each suspect transaction having a parameter, the parameter of each transaction being substantially consistent;
identifying, by the computing device, at least one like merchant based on a proximity of the at least one like merchant to the source merchant;
determining, by the computing device, a travel time between the source merchant and the at least one like merchant; and
deploying at least one fraud prevention rule at the at least one like merchant during a fraud risk interval, the at least one fraud prevention rule based on the parameter of at least one of the multiple suspect transactions, and the fraud risk interval based on the determined travel time, thereby permitting the detected fraud condition to alter one or more other fraud prevention rules associated with the at least one like merchant, based on the deployed at least one fraud prevention rule, to target fraud at the at least one like merchant consistent with the detected fraud event.

2. The computer-implemented method of claim 1, wherein the parameter of each suspect transaction that is substantially consistent includes a first parameter comprising an amount of the suspect transaction; and
wherein each suspect transaction includes a second parameter that is substantially consent among the multiple suspect transactions, the second parameter comprising a product type.

3. The computer-implemented method of claim 1, further comprising generating, by the computing device, the fraud risk interval based on the travel time and at least one deployment period; and
withdrawing the at least one fraud prevention rule after the fraud risk interval.

4. The computer-implemented method of claim 3, wherein the fraud risk interval is further based on a time of one of the multiple suspect transactions at the source merchant.

5. The computer-implemented method of claim 1, wherein identifying the at least one like merchant is further based on a merchant category code (MCC) associated with the source merchant.

6. The computer-implemented method of claim 1, further comprising compiling the at least one fraud prevention rule based on the detected fraud condition.

7. The computer-implemented method of claim 6, wherein the at least one fraud prevention rule includes an amount, which is within a threshold of an amount of at least one of the suspect transactions, and a product which is the same as the product of at least one of the suspect transactions.

8. The computer-implemented method of claim 1, wherein deploying the at least one fraud prevention rule at the at least one like merchant includes deploying the at least one fraud prevention rule via a payment network and/or an issuer configured to facilitate payment account transactions performed at the at least one like merchant.

9. A computer-readable storage media including executable instructions for use in providing fraud prevention rules, which when executed by at least one processor, cause the at least one processor to:
identify a like merchant to a source merchant based on a merchant category of the source merchant and in response to a detected fraud condition associated with the source merchant;
determine a fraud risk interval for the like merchant based on a proximity of the like merchant to the source merchant;
compile a fraud prevention rule based on the detected fraud condition; and
deploy the fraud prevention rule for payment account transactions at the like merchant, for the fraud risk interval, thereby altering the fraud prevention rules associated with the like merchant for the fraud risk interval, based on the compiled fraud prevention rule, to target payment account transactions at the like merchant consistent with the fraud condition.

10. The computer-readable storage media of claim 9, wherein the executable instructions, when executed by the at least one processor, cause the at least one processor to determine a travel time from the source merchant to the like merchant based on the proximity of the like merchant to the source merchant, and to determine the fraud risk interval based on the determined travel time.

11. The computer-readable storage media of claim 9, wherein the like merchant includes multiple like merchants, each having a proximity to the source merchant; and
wherein the executable instructions, when executed by the at least one processor, cause the at least one processor to determine a fraud risk interval for each of the multiple like merchants.

12. The computer-readable storage media of claim 11, wherein the merchant category includes the merchant category code (MCC) of the source merchant.

13. The computer-readable media of claim 9, wherein the computer executable instructions, when executed by the at least one processor, further cause the at least one processor to:
identifying a second like merchant based on the merchant category, in response to a detected second fraud condition at the like merchant;
determine a second fraud risk interval for the second like merchant, based on a proximity of the second like merchant to the like merchant; and
deploy a second fraud prevention rule for transactions to the second like merchant for the second fraud risk interval.

14. The computer-readable storage media of claim 13, wherein the computer executable instructions, when executed by the at least one processor, further cause the at least one processor to determine the second fraud prevention rule based on the detected second fraud condition.

15. The computer-readable storage media of claim 9, wherein the executable instructions, when executed by the at least one processor, further cause the at least one processor to identify the like merchant based on multiple transactions having a similar amount within a trigger interval and being directed to a similar product.

16. A computer-implemented method for deploying fraud prevention rules in response to detected fraud conditions, the method comprising:
identifying, by a computing device, a like merchant to a source merchant in response to a detected flash fraud condition associated with the source merchant and based on the like merchant having the same merchant category as the source merchant and on the like merchant being within a predefined proximity of the source merchant;
determining a travel time between the source merchant and the like merchant;
generating, by the computing device, a deployment time for the like merchant;
generating, by the computing device, a fraud risk interval for the like merchant based at least on the travel time between the source merchant and the like merchant, the deployment time, and a time of the detected flash fraud condition;
compiling, by the computing device, at least one fraud prevention rule based on the detected flash fraud condition; and
deploying the at least one fraud prevention rule for payment account transactions at the like merchant, for the fraud risk interval, thereby altering existing fraud prevention rules associated with the like merchant for the fraud risk interval, based on the compiled at least one fraud prevention rule, to target payment account transactions at the like merchant consistent with the flash fraud condition.

17. The computer-implemented method of claim 16, wherein the at least one fraud prevention rule includes an amount, which is within a threshold of an amount of a transaction associated with the flash fraud condition, and a product indictor, which includes the product of the transaction associated with the flash fraud condition.

18. The computer-implemented method of claim 17, wherein the merchant category includes a merchant category code (MCC) associated with the source merchant.

19. The computer-implemented method of claim 17, further comprising withdrawing the at least one fraud prevention rule after the fraud risk interval.

20. The computer-implemented method of claim 16, wherein deploying the at least one fraud prevention rule includes deploying the at least one fraud prevention rule via a payment network and/or an issuer configured to facilitate the payment account transactions performed at the like merchant.
